(19) United States
(12) Patent Application Publication
(10) Pub. No.: US 2025/0131555 A1
(43) Pub. Date: Apr. 24, 2025

(54) METHOD, APPARATUS, AND COMPUTER-READABLE MEDIUM FOR INSPECTING COSMETIC PACKAGING DESIGN BASED ON OBJECT RECOGNITION AND POLICY

(71) Applicant: MayCoders, INC., Seoul (KR)

(72) Inventors: Saemi CHOI, Seoul (KR); Seokjin HONG, Seoul (KR)

(21) Appl. No.: 18/503,345

(22) Filed: Nov. 7, 2023

(30) Foreign Application Priority Data
Oct. 23, 2023 (KR) 10-2023-0141748

(51) Int. Cl. G06T 7/00; G06F 40/279; G06V 30/148

(52) U.S. Cl. CPC G06T 7/001; G06F 40/279; G06V 30/153; G06T 2207/30108

(57) ABSTRACT

A method for inspecting a cosmetic packaging design based on object recognition and policy includes: a data extracting step of extracting, when design data of packaging paper is collected from an external terminal, product information data indicating attribute information of cosmetics including at least text information, as information included in design data; a description checking unit that determines whether there exists essential description of the attribute information of the cosmetics based on the product information data extracted from the data extracting step and a pre-stored attribute information regulation for cosmetics; a description suitability determining unit that determines description suitability of the product information data based on the product information data and the attribute information regulation, when the essential description exists; and a result providing step of providing a user account with result data generated as a result of the description checking step and the description suitability determining step.

### BACKGROUND OF THE INVENTION

### 1. Field of the Invention

The present invention relates to a technology for determining descriptions and errors for essential descriptions, which are prescribed by the Act, of packaging paper including a packaging label or packaging box for a cosmetic container, and more specifically, to a technology for enhancing precision in printing of a packaging paper design and minimizing cost consumption due to post-processing of errors by precisely determining whether the essential descriptions prescribed for each attribute of a product are complied with in the Cosmetics Act in a design step before a packaging paper printing step.

### 2. Description of the Related Art

With the recent development of the K-beauty industry, a wide variety of cosmetics are being released and sold. As for the cosmetics, a wide variety of products ranging from basic products to tone and functional products are being released, and users purchase and use the cosmetics that suit them based on advertisements for cosmetics, indirect advertisements by celebrities, and their history of use.

In this case, it is common to determine whether the cosmetics are optimized for oneself and the reliability of the advertisement based on the description of the ingredients contained in the cosmetics or the like. That is, functional cosmetics are sold by marking ingredients, content units, and manufacturers, sellers, and the like on a variety of products for packaging and containing cosmetics, in addition to the names of cosmetics. The users purchase the cosmetics suitable for them by confirming the descriptions marked on an exterior of the cosmetics and receiving the ingredients and a guide for use.

When the descriptions of the cosmetics are different for each cosmetic, it may cause confusion in the users' determination, and when the descriptions of essential elements are omitted, the reliability of the cosmetics directly acting on the user's skin is deteriorated. Therefore, Article 10 of the Cosmetics Act, etc., stipulates that the contents need to be described in the primary or secondary packaging, which refers to the packaging label and packaging box of the cosmetic container, etc., as prescribed by the Ordinance of the Prime Minister.

Failure to comply with the regulations is punishable by prohibiting the sale of the product pursuant to Article 16 of the Cosmetics Act, so that it is necessary to comply with the regulations on essential descriptions and various descriptions of the packaging paper.

However, Korean Unexamined Patent Publication No. 10-2014-0013760 has disclosed only technology for simply providing information about ingredients, etc., as attribute information about cosmetics in two-dimensional codes, etc. In particular, it is common for human resources such as designers who design packaging paper for the above cosmetics to have poor expertise in the above essential descriptions, but it is difficult to immediately grasp whether the packaging paper for the cosmetics designed by themselves complies with the regulations stipulated in the Cosmetics Act with only simple information providing technology. If such compliance with the regulations is not properly confirmed, when the above error is found after the design is confirmed and printed, there is a concern about severe damage such as discarding the entire packaging paper or stopping the sale of cosmetics, but there is no proper technology to prevent the damage in advance.

### SUMMARY OF THE INVENTION

Accordingly, an object of the present invention is to provide a technology for rapidly and precisely confirming whether a design of packaging paper complies with the Cosmetics Act to minimize the waste of resources, cost, and time due to the lack of confirmation of compliance with the regulations as described above by processing only design data for the packaging paper generated in a design step before printing through object recognition, data extraction, natural language processing, etc. for packaging paper of cosmetics.

To achieve the above object, according to one embodiment of the present invention, a method for inspecting a cosmetic packaging design based on object recognition and policy includes: a data extracting step of extracting, when design data of packaging paper including a packaging label or packaging box of a cosmetic container is collected from an external terminal, product information data indicating attribute information of cosmetics including at least text information, as information included in design data; a description checking step of determining whether there exists essential description of the attribute information of the cosmetics, which is required to be described on the packaging paper, based on the product information data extracted from the data extracting step and a pre-stored attribute information regulation for cosmetics; a description suitability determining step of determining description suitability of the product information data based on the product information data about the essential description and the attribute information regulation, when the essential description exists; and a result providing step of providing a user account with result data that is generated as a result of the description checking step and the description suitability determining step.

The data extracting step may include: a first extracting step of collecting first text by separating text from an image when the design data is data in which the image and text are combined; a second extracting step of collecting second text by extracting text information from the image using an artificial intelligence character recognition and keyword extraction algorithm for the image; and a third extracting step of extracting product information data, which corresponds to a classification value of each attribute information of the cosmetics, from the first text and the second text by using a natural language semantic mining algorithm for the first text and the second text, to assign the product information data to the classification value of each attribute information.

The description checking step may include checking whether the essential descriptions are described based on existence of product information data in the attribute information about all essential descriptions by matching the attribute information, which is assigned to each extracted product information data, based on the classification value of the attribute information of the essential description.

The description checking step may include additionally checking existence of a mark of functionality information and product information data about ultraviolet protection levels including SPF and PA in the essential description, when there exists product information data about at least one of the functionality information and information about whether the cosmetic is a sun care product in the attribute information.

A classification value of the attribute information of the essential description may include a brand name, a cosmetic name, a capacity, a manufacturer, a responsible seller, a manufacturing number, and a total ingredient table, may further include a functionality mark when the cosmetic is functional cosmetics, and may further include an ultraviolet protection level when the cosmetic is a sun care product.

The description suitability determining step may include: a reference information extracting step of extracting reference information about the description suitability by applying the classification value of the attribute information of the essential description to which the product information data belongs to the pre-stored attribute information regulation of the cosmetics; and a determining step of determining whether the extracted product information data satisfies each reference information by applying the extracted reference information to each extracted product information data.

The reference information may be one of a first reference in which an ingredient name written in a total ingredient table is to be marked when the ingredient name is written in a cosmetic name, and a second reference in which there is a keyword corresponding to ingredient information, which corresponds to a functionality mark, in the total ingredient table when there is the keyword indicating the functional cosmetics.

The method may further include, after the description checking step: an additional data identifying step of determining whether there exists additional data, which is product information data other than the essential description; an additional data generating step of generating recommended additional data, which is information about usage, storage, and cautions for handling of the cosmetics, as information that is generated using a generation-type artificial intelligence algorithm for the product information data; and a data recommending step of providing the user account with the additional data and the recommended additional data generated in the additional data generating step so that the user account recognizes information to be added to the design data.

Meanwhile, according to one embodiment of the present invention, an apparatus for inspecting a cosmetic packaging design based on object recognition and policy includes: a data extracting unit that extracts, when design data of packaging paper including a packaging label or packaging box of a cosmetic container is collected from an external terminal, product information data indicating attribute information of cosmetics including at least text information, as information included in the design data; a description checking unit that determines whether there exists essential description of the attribute information of the cosmetics, which is required to be described on the packaging paper, based on the product information data extracted from the data extracting step and a pre-stored attribute information regulation for cosmetics; a description suitability determining unit that determines description suitability of the product information data based on the product information data about the essential description and the attribute information regulation, when the essential description exists; and a result providing unit that provides a user account with result data that is generated as a result of performing functions of the description checking unit and the description suitability determining unit.

According to the present invention, when design data about the packaging paper is received, text described on the packaging paper is extracted by using separation of text data, a character recognition algorithm, etc., the extracted text is subjected to natural language processing and is classified and defined as attribute information corresponding to essential description and the like of cosmetics, and the classified and defined text is applied to regulations such as the Cosmetics Act to determine description and suitable description of the essential description.

Accordingly, it is possible to determine whether the packaging paper, which has been designed in advance in the design planning step before printing the packaging paper, conforms to the regulations prescribed by the Cosmetics Act, and to correct errors thereof, thereby completely eliminating severe damage caused by discovering the errors after printing and detecting the errors after launching products.

Further, since additional information about cosmetics may be recommended and added, it is also possible to expect an effect of increasing the sales rate through addition of the appropriate design and contents to cosmetic packaging paper.

### BRIEF DESCRIPTION OF THE DRAWINGS

FIGS. 1 to 4 are flowcharts showing a method for inspecting a cosmetic packaging design based on object recognition and policy according to one embodiment of the present invention.

FIG. 5 is a block diagram showing a configuration of an apparatus for inspecting a cosmetic packaging design based on object recognition and policy according to one embodiment of the present invention.

FIG. 6 is a view showing an example of design data for explaining an example in which data is extracted according to one embodiment of the present invention.

FIG. 7 is a view showing an example for explaining a flow of determining description and description suitability according to one embodiment of the present invention.

FIG. 8 is a view showing an example of a screen on which result data is output to a user terminal according to one embodiment of the present invention.

FIG. 9 is a view showing an example of an internal configuration of a computing device according to one embodiment of the present invention.

### DETAILED DESCRIPTION OF THE INVENTION

Hereinafter, various embodiments and/or aspects will be disclosed with reference to the drawings. In the following description, multiple concrete details will be disclosed in order to help general understanding of one or more aspects for the purpose of description. However, it will also be appreciated by those skilled in the art to which the present invention pertains that such aspect(s) may be practiced without the specific details. In the following description and accompanying drawings, specific exemplary aspects of one or more aspects will be described in detail. However, the aspects are exemplary, and some equivalents of various aspects may be used, and the descriptions herein are intended to include both the aspects and equivalents thereto.

The terms “embodiment”, “example”, “aspect”, “illustration”, and the like used herein may not be construed as indicating that any aspect or design set forth herein is preferable or advantageous over other aspects or designs.

In addition, it is to be understood that the terms “include” and/or “comprise” indicate the presence of corresponding features and/or elements, but do not preclude the presence or addition of one or more other features, elements, and/or groups thereof.

In addition, although the terms including ordinal numbers such as “first” and “second” may be used to describe various elements, the elements are not limited by the terms. The above terms are used merely for the purpose of distinguishing one element from another element. For example, a first element may be termed as a second element, and similarly, a second element may also be termed as a first element without departing from the scope of the present invention. The term “and/or” includes any combination of a plurality of described relevant items, or one of the described relevant items.

In addition, unless defined otherwise, all terms used in embodiments of the present invention, including technical and scientific terms, have the same meaning as those commonly understood by a person having ordinary skill in the art to which the present invention pertains. Terms as those defined in generally used dictionaries are to be interpreted to have the meanings consistent with the contextual meanings in the relevant field of art, and are not to be interpreted to have idealistic or excessively formalistic meanings unless explicitly defined in the embodiments of the present invention.

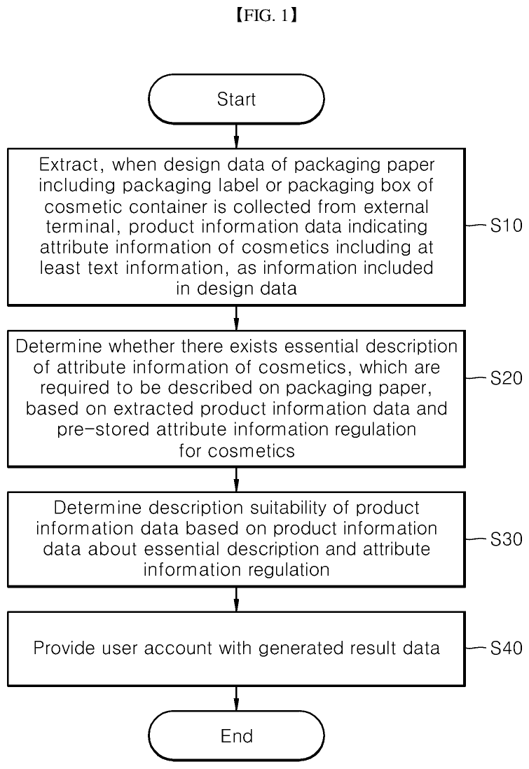

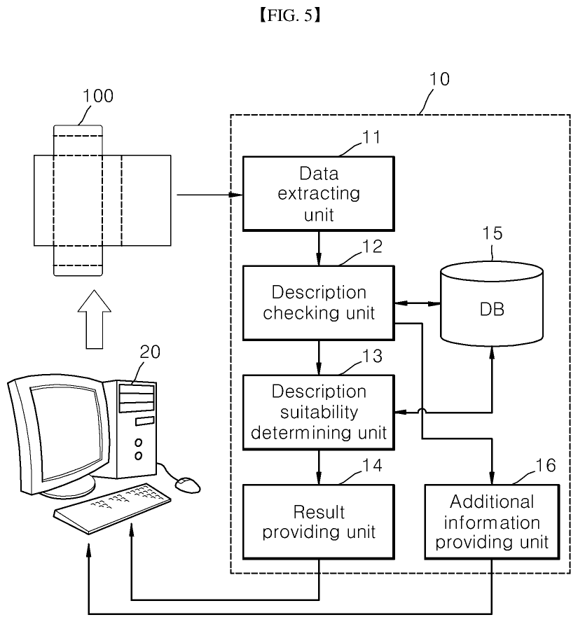

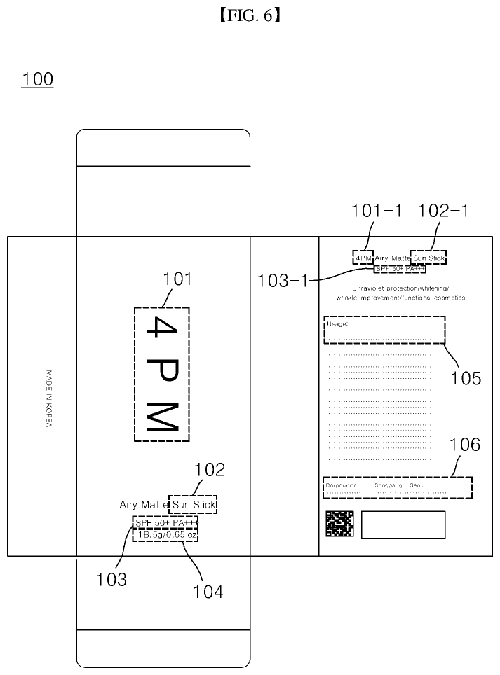

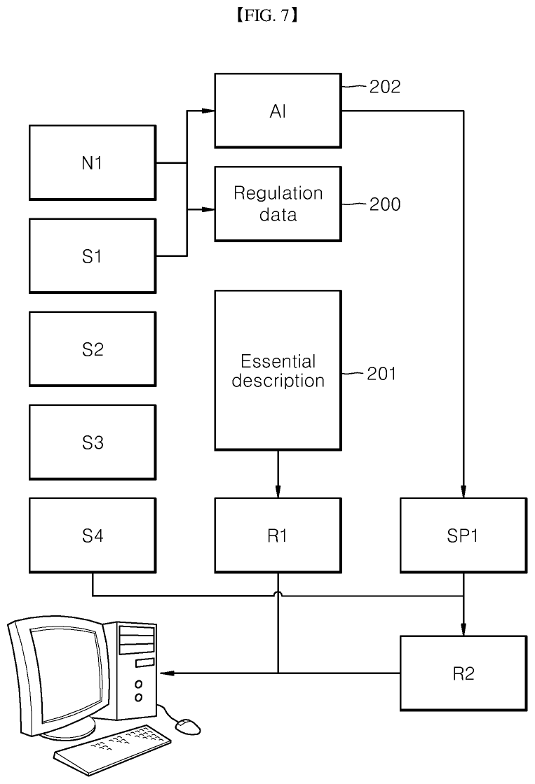

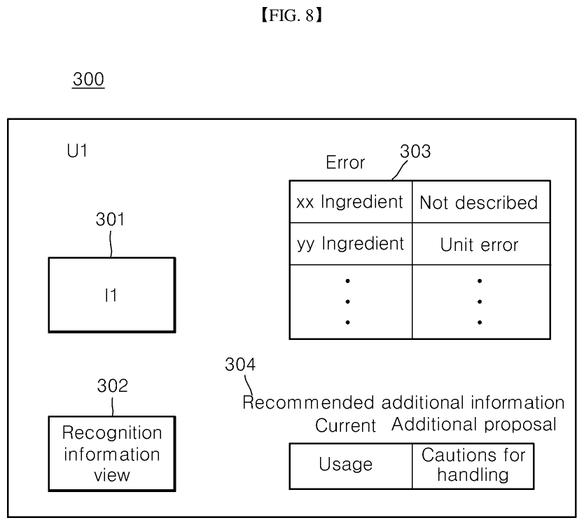

FIGS. 1 to 4 are flowcharts of a method for inspecting a cosmetic packaging design based on object recognition and policy according to one embodiment of the present invention, FIG. 5 is a block diagram showing a configuration of an apparatus for inspecting a cosmetic packaging design based on object recognition and policy according to one embodiment of the present invention, FIG. 6 is a view showing an example of design data for explaining an example in which data is extracted according to one embodiment of the present invention, FIG. 7 is a view showing an example for explaining a flow of determining description and description suitability according to one embodiment of the present invention, and FIG. 8 is a view showing an example of a screen on which result data is output to a user terminal according to one embodiment of the present invention. In the following description, the descriptions will be made with reference to a plurality of accompanying drawings in order to describe various embodiments and components of the present invention.

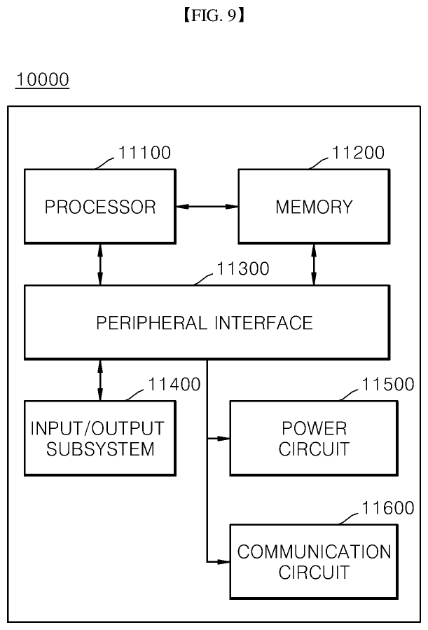

It will be understood that the method for inspecting a cosmetic packaging design based on object recognition and policy according to one embodiment of the present invention, which is shown in FIGS. 1 to 4, is performed by an apparatus 10 for inspecting a cosmetic packaging design based on object recognition and policy (hereinafter referred to as an ‘apparatus of the present invention’), which is shown in FIG. 5 and which will be described later, and is performed by detailed components constituting the apparatus, or is performed in a computing device to be mentioned in the description of FIG. 9. That is, the apparatus 10 of the present invention may include a computing device, some detailed components of the computing device, and a plurality of groupware of the computing device.

On the basis, first, as shown in FIGS. 1 to 4, the method for inspecting a cosmetic packaging design based on object recognition and policy according to one embodiment of the present invention performs, by the computing device, a data extracting step S10 of extracting, when design data of packaging paper including a packaging label or packaging box of a cosmetic container is collected from an external terminal, product information data indicating attribute information of cosmetics including at least text information, as information included in design data.

The packaging label and packaging box of a cosmetic container are a concept including a first packaging and a second packaging prescribed by the Cosmetics Act, which will be understood as a printed matter in which all descriptions of ingredients, names, manufacturer, and the like of cosmetics are printed. When the printing is performed based on the design data, each packaging paper is assembled as a box for containing the cosmetic container or is attached to the cosmetic container according to the shape thereof.

The design data is, for example, image data in the form of a two-dimensional plane which is in the form of an exploded view capable of constituting the container and box as described above, and includes colors, patterns, texts, and the like of the packaging paper. In this case, the text data may exist to be recognized as a separate file that is combined with the included in the image data by image data, or may be constituting the image data together.

In step S10, the computing device extracts product information data indicating attribute information of cosmetics including text information, and includes a matching process for each type of attribute information through extraction of the text information and recognition of the text information.

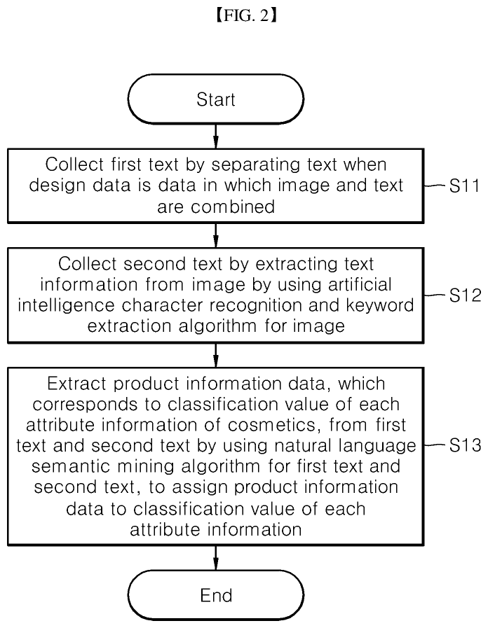

For example, the above process may be understood through an embodiment as shown in FIGS. 2 and 6. First, when the design image is data in which an image and text are combined, the computing device performs a first extracting step S11 of collecting first text by separating the text and a second extracting step S12 of collecting second text by extracting the text information from the image by using an artificial intelligence character recognition and keyword extraction algorithm for the image, thereby extracting all texts included in the design data as the first and second texts. In this case, in step S12, the text may be extracted using an artificial intelligence OCR program or various deep learning techniques.

When the process is completed, all texts 101, 102, 103, 104, 105, 106, 101-1, 102-1, and 103-1 belonging to design data 100 are extracted as shown in FIG. 6.

When the texts are extracted, the computing device performs a third extracting step S13 of extracting product information data, which corresponds to a classification value of each attribute information of the cosmetics, from the first text and the second text by using a natural language semantic mining algorithm for the first text and the second text, to assign the product information data to the classification value of each attribute information.

The product information data means a process of extracting keywords (words) corresponding to each product information through natural language processing on the text, for example. According to the present invention, a character recognition process collectively refers to a process of recognizing characters from scan data by performing the OCR program described above to make the characters into text sentence.

Accordingly, the character recognition process according to the present invention may be understood as a process of deriving word and sentence information from the recognized characters by using not only the OCR program but also a morpheme analysis algorithm, a natural language processing algorithm, etc.

According to the present invention, the keyword may be understood as a concept including a word or the like recognized and extracted as having a meaning in a specific text through morpheme analysis, vector analysis, or the like. The words constituting the text may be extracted by applying a TextRank or WordRank algorithm.

Meanwhile, the keyword may further include unstructured data such as an image and a logo instead of structured data such as text. For example, the keyword may include water droplets representing purified water, a chemical formula symbol representing a specific chemical formula, etc. In this case, as an information extraction algorithm from the image data using deep learning or the like, for example, a process of acquiring a label of an image using Deeplab, which is one of semantic segmentation techniques, constituting a keyword with the acquired label information, and performing automatic tagging on the image may be performed. In this case, the tagged information may be extracted and presented as a keyword that includes background information as well as objects in the image to enhance the overall understanding of the image and presents a priority in consideration of an area occupied in the image.

When such words are extracted, the keywords are classified into any one of classification values of each attribute information through a keyword matching operation related to cosmetics, and product information data corresponding to the classification values of each attribute information is extracted based on the classified values, thereby extracting what product information the keywords correspond to and what meaning or content the product information includes.

The classification value of the attribute information may be classified into a brand name, a cosmetic name, a capacity, a cosmetic manufacturer, a responsible cosmetic seller, a manufacturing number, a total ingredient table, a functionality mark, an ultraviolet protection level mark, and the like, according to the example of the above Cosmetics Act.

The brand name may be configured by determining match of a database of a brand name, which is collected online such as web site, with the extracted text, and when the brand name is not classified as a classification value of other attribute information and has no specific meaning, for example, an embodiment in which a brand name written in the largest font is registered in the database as a new brand name may be performed.

The cosmetic name may be configured as a text including cosmetic category (e.g., toner, skin, essence, and sun stick) registered in the database among texts excluding text written in the smallest font size among the remaining texts excluding text corresponding to the brand name.

The capacity may be obtained by classifying a text recognition result including a unit, that is, g, oz, fl, Oz, and the like, regardless of a size. The cosmetic manufacturer may be classified as text having similar expressions such as a cosmetic manufacturer, a cosmetic manufacturer and seller, and a cosmetic maker, or text that matches a company adjacent to or appearing after the above text or a manufacturer inquired through an online business inquiry, regardless of a size.

Similar to the cosmetic manufacturer, the cosmetic responsible seller may be classified as text having similar expressions such as a cosmetic responsible seller, a cosmetic manufacturer and seller, and a cosmetic seller, or text that matches a company adjacent to or appearing after the above text or a manufacturer inquired through an online business inquiry.

The manufacturing number may be classified as a series of numbers adjacent to text having similar expressions such as a manufacturing number, separate indication of a usage period, a validity period, and an expiration period regardless of a size. The total ingredient table may be specified using a comma and the like, and may be classified as text for a section including determination on existence of a list of ingredient names in Korean and English according to match of keywords included in a chemical or natural material database, longest text or water or “purified water”.

The functionality mark may be classified based on match of Korean and English marks for whitening, wrinkle improvement, ultraviolet protection, dyeing, hair removal, acne relief, hair loss relief, and the like, and existence of a templated mark for ultraviolet protection levels such as SPF 50+ and PA++++.

Through such a meaning and word matching process, the classification value of each attribute information is assigned to the extracted text and extracted as product information data.

When step S10 is completed, the computing device performs a description checking step S20 of determining whether there exists essential description of the attribute information of the cosmetics, which is required to be described on the packaging paper, based on the product information data extracted from step S10 and a pre-stored attribute information regulation for cosmetics.

Step S20 may be understood as a process of determining all definitions and descriptions of the classification value of the attribute information corresponding to the essential description prescribed by Article 10 of the Cosmetics Act, etc., based on the product information data to which the classification value of each attribute information is assigned.

That is, in step S20, specifically, for example, the computing device checks the description of the essential description based on existence of product information data in the attribute information about all essential descriptions by matching the attribute information, which is assigned to each extracted product information data, based on the classification value of the attribute information of the essential description.

In this case, among the classification values of each attribute information, essential description may be implemented differently according to the type of a product. For example, when there exists a content about a functional or sun care product in the product information data to which the classification value of the attribute information such as a cosmetic name is assigned, or when it is determined that there exists product information data corresponding to the classification value of the attribute information due to the existence of a functionality mark or a mark for a sun care product other than the cosmetic name, there is need for product information data to which the classification value of the attribute information that is to be additionally described differently from other cosmetics.

That is, in step S20, the computing device may perform a process of additionally checking existence of a mark of functionality information and product information data about ultraviolet protection levels including SPF and PA in the essential description, when there exists product information data about at least one of the functionality information and information about whether the cosmetic is a sun care product in the attribute information.

As described above, the classification value of the attribute information of the essential description may include a brand name, a cosmetic name, a capacity, a manufacturer, a responsible seller, a manufacturing number, and a total ingredient table, may further include a functionality mark when the cosmetic is functional cosmetics, and may further include an ultraviolet protection level when the cosmetic is a sun care product, and the classification value of the attribute information may be updated and managed with different naming and classification values based on changes and revisions of the regulations such as the Cosmetics Act described above.

As described above, as a result of determining the existence of the essential description as in step S20, when there exists the classification value of the attribute information that does not exist, the classification value of the attribute information is included in result data provided in step S30 and the like, which will be described later, thereby allowing a user account, that is, a designer or a manager who manages the manufacture and sale of cosmetics to recognize the result data and modify the design data.

Meanwhile, when it is determined in step S20 that there exist all the product information data to which the classification value of the attribute information corresponding to the essential description is assigned. That is, when the essential description a exists, description suitability determining step S30 of determining description suitability of the product information data based on the product information data about the essential description and the attribute information regulation is performed.

As shown in FIG. 7, the above-described series of processes may be understood as performing determination on existence of the essential description (S20) and suitability of the essential description (S30) by applying the essential description to regulation data 200 based on the brand name and the cosmetic name (N1), the functionality mark or sun care product mark (S1), and other product information data (S2, S3, and S4).

In this case, when it is determined that the essential description is suitable or when the essential description does not exist or is not suitable as described above, information about the determination result and the classification value of the product information data and the attribute information, which are factors of the result, may be generated as the result data R1 as a result of steps S20 and S30. In this case, the computing device may perform a result providing step S40 of providing the user account with the generated result data R1 after the step S30.

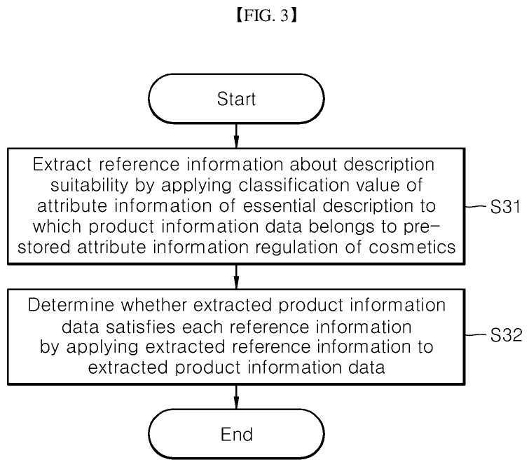

Meanwhile, in step S30, a specific process may be performed. That is, as shown in FIG. 3, first, the computing device performs a reference information extracting step S31 of extracting reference information about the description suitability by applying the classification value of the attribute information of the essential description to which the product information data belongs to the pre-stored attribute information regulation of the cosmetics. As described above, the reference information may be extracted by searching for an attribute information regulation of cosmetics, which has the classification value of the attribute information assigned to each product information data, that is, a regulation for the essential description, and the like.

Thereafter, a determination step S32 of determining whether the extracted product information data satisfies each reference information by applying the extracted reference product information data is information to the extracted performed, thereby completing step S30. That is, after information about the description reference is extracted using step S31 based on the classification value of the attribute information assigned to the product information data, the extracted information is compared with the actual product information data to determine description of the product information data according to the rule of the essential description through step S32.

Examples of the reference information may include regulations for the cosmetic name and total ingredient table. For example, when the ingredient name is written in the cosmetic name, the content of the corresponding ingredient name is necessarily marked in the total ingredient table. First, it is determined existence of the ingredient name in the cosmetic name using step S31, and when there exists the ingredient name in the cosmetic name, the reference information may be extracted through an inquiry of a regulation in which the content of the corresponding ingredient is to be marked in the total ingredient table as the regulation therefor.

In this case, as in step S32, a test of the total ingredient table is analyzed to confirm the mark of the same or different type of the corresponding ingredient, and confirmation that text such as the content (n %) of the corresponding ingredient is marked next to (on the right side of) the corresponding ingredient as auxiliary information.

Meanwhile, regulations for the functionality mark and the total ingredient table may also be applied. That is, when the cosmetics are recognized as functional cosmetics because of the functionality mark, the functional cosmetics are separately designated according to the reference and test method thereof, a regulation database therefor is loaded, at least one ingredient and/or content thereof is required to be displayed in the ingredient information database according to each functionality, and otherwise, it is determined as text that is not suitable.

That is, as described in the above example, the reference information may be applied by including, by way of example, one of a first reference in which an ingredient name written in the total ingredient table is to be marked when the ingredient name is written in a cosmetic name, and a second reference in which there is a keyword corresponding to ingredient information, which corresponds to a functionality mark, in the total ingredient table when there is the keyword indicating the functional cosmetics.

Meanwhile, in addition to the above-described essential description, a usage of cosmetics or cautions for handling cosmetics may be additionally added to provide a guide for users on the use of cosmetics, and may be marked on various packaging papers of cosmetics. In this case, the sales rate may be increased by stimulating the purchase desire of the users through the provision of abundant information about the product to the users, and the guide and recommendation information about the product may also be provided as an additional process using the text analysis result, which may be additionally performed according to the steps S10 to S30.

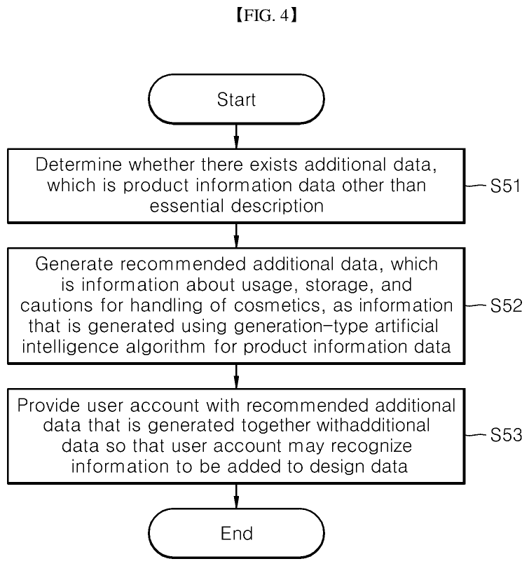

To this end, as shown in FIG. 4, the computing device performs an additional data identifying step S51 of determining whether there exists additional data, which is product information data other than the essential description. For example, step S51 may be understood as a process of recognizing texts including information about, for example, “usage”, “cautions for handling”, and the like, among all texts except for the text to which the classification value of the attribute information determined as the essential description as a result of step S20 is assigned.

Thereafter, an additional data generating step S52 of generating recommended additional data, which is information about usage, storage, and cautions for handling of cosmetics, information that is generated using a generation-type as artificial intelligence algorithm for the product information data is performed.

Step S52 means, for example, a process of applying information about a cosmetic name or a total ingredient table and a category of cosmetics to a generation-type artificial intelligence algorithm 202 such as ChatGPT to generate a phrase on usage, storage, and cautions for handling as shown in FIG. 7, and may be understood as a process of generating a phrase as a result of inputting category information (N1, S1) of cosmetics extracted from the cosmetic name, product information data on the total ingredient table and the like, and the phrases of “usage” and “cautions for handling” into the algorithm.

Thereafter, a data recommending step S53 of providing the user account with recommended additional data SP1 generated in the additional data generating step S52 and additional data S4 detected in step S51 together with the result data R1 as second result data R2 so that the user account may recognize information to be added to the design data.

According to the present invention, the users may be provided with results for determining compliance with essential descriptions, and at the same time, the users may be provided with information which may be expected to improve the sales rate by providing a guidance to the users for assistance in the description of the corresponding cosmetics, thereby enabling the information to be used in editing design ideas.

All the information may be combined and displayed on a screen 300 as shown in FIG. 8. That is, a user Ul may confirm design data 301 on his/her interface screen 300, and at the same time, may inquire, in detail, the product information data recognized through step S10 and the classification value of the attribute information to which each product information data belongs through a recognition information view menu 302.

Meanwhile, the error view information 303 is first result data, and may confirm information about omission of the essential description and non-suitable description, and recommended additional information 304 is second result data, and may allow the user account to recognize information to be added to the design data.

Accordingly, it is determined whether the packaging paper that is pre-designed in the design planning step before printing the packaging paper is suitable for the regulations prescribed by the Cosmetics Act, and errors of the packaging paper may be corrected, so that it is possible to completely eliminate severe damage caused by discovery the errors after printing and detection the error after launching the product.

Further, additional information about cosmetics may be recommended and added, so that an increase in sales rate may also be expected by adding suitable designs and contents to the packaging paper of cosmetics.

FIG. 5 is a block diagram showing a configuration of the apparatus 10 according to the present invention. In the following descriptions, descriptions overlapping with the above descriptions will be omitted. The apparatus 10 of the present invention includes a data extracting unit 11, a description checking unit 12, a description suitability determining unit 13, and a result providing unit 14 as key components. The apparatus 10 of the present invention may further include a database 15 and an additional information providing unit 16. The database 15 refers to a configuration in which data or a program such an algorithm managed according to the performance of all functions of the present invention, such as a memory of the device 10 or a storage space of a connected cloud server, is stored and managed.

The data extracting unit 11 is a configuration that performs all functions described in the above description of steps S10, S11, S12, and S13, and performs a function of extracting product information data indicating attribute information of cosmetics including at least text information as information included in the design data 100 when the design data 100 of the packaging paper including a packaging label or packaging box of a cosmetic container is collected from an external terminal 20 (user terminal).

The description checking unit 12 is a configuration that performs all functions described in the above description of step S20, and performs a function of determining whether there exists essential description of the attribute information of cosmetics, which is required to be described on the packaging paper, based on the product information data extracted from the data extracting unit 11 and a pre-stored attribute information regulation for cosmetics.

The description suitability determining unit 13 is a configuration that performs all functions described in the above description of steps S30, S31, and S32, and performs a function of determining description suitability of the product information data based on the product information data about the essential description and the attribute information regulation, when the essential description exists.

The result providing unit 14 is a configuration that performs all functions described in the above description of step S40, and performs a function of providing a user account with result data that is generated as a result of performing functions of the description checking unit 12 and the description suitability determining unit 13.

Meanwhile, the additional information providing unit 16 as a configuration that performs all may be understood functions mentioned in the above description of steps S51 to S53.

FIG. 9 is a view showing an example of an internal configuration of the computing device according to one embodiment of the present invention. In the following description, redundant descriptions of the embodiment corresponding to the above descriptions for FIGS. 1 to 8 will be omitted.

As shown in FIG. 9, a computing device 10000 may at least include at least one processor 11100, a memory 11200, a peripheral interface 11300, an input/output (I/O) subsystem 11400, a power circuit 11500, and a communication circuit 11600. In this case, the computing device 10000 may correspond to a user terminal A connected to a tactile interface device, or correspond to a computing device B described above.

The memory 11200 may include, for example, a high-speed random access memory, a magnetic disk, an SRAM, a DRAM, a ROM, a flash memory, or a non-volatile memory. The memory 11200 may include a software module, an instruction set, or other various data necessary for the operation of the computing device 10000.

In this case, access to the memory 11200 from other components such as the processor 11100 or the peripheral interface 11300 may be controlled by the processor 11100.

The peripheral interface 11300 may couple an input and/or output peripheral device of the computing device 10000 to the processor 11100 and the memory 11200. The processor 11100 may execute the software module or the instruction set stored in the memory 11200, thereby performing various functions for the computing device 10000 and processing data.

The I/O subsystem 11400 may couple various input/output peripheral devices to the peripheral interface 11300. For example, the input/output subsystem 11400 may include a controller for combining the peripheral device such as monitor, keyboard, mouse, printer, or a touch screen or sensor, if needed, to the peripheral interface 11300. According to another aspect, the input/output peripheral devices may be combined to the peripheral interface 11300 without passing through the input/output subsystem 11400.

The power circuit 11500 may supply a power to all or some of the components of the terminal. The power circuit 11500 may include a power management system, one or more power supplies such as a battery or alternating current (AC), a charging system, a power failure detection circuit, a power converter or inverter, a power status indicator, or any other components for power generation, management, and distribution.

The communication circuit 11600 may use at least one external port to enable communication with other computing devices.

Alternatively, as described above, the communication circuit 11600 may include an RF circuit, if necessary, to transmit and receive an RF signal, also known as an electromagnetic signal, thereby enabling the communication with other computing devices.

The above embodiment of FIG. 9 is merely one example of the computing device 10000, and the computing device 10000 may have a configuration or arrangement that omits some of the components shown in FIG. 9, further includes an additional component that is not shown in FIG. 9, or combines at least two components. For example, a computing device for a communication terminal in a mobile environment may further include a touch screen, a sensor, or the like, in addition to the components shown in FIG. 9. The communication circuit 11600 may include a circuit for RF communication of various communication schemes (such as WiFi, 3G, LTE, Bluetooth, NFC, and Zigbee). The components that may be included in the computing device 10000 may be implemented by hardware, software, or a combination of both hardware and software which include at least one integrated circuit specialized in a signal processing or an application.

The methods according to the embodiment of the present invention may be implemented in the form of program instructions that may be executed through various computing devices, and may be recorded in a computer-readable medium. In particular, a program according to the embodiment of the present invention may be configured as a PC-based program or an application dedicated to a mobile terminal. The application to which the present invention is applied may be installed in a user terminal through a file provided by a file distribution system. For example, a file distribution system may include a file transmission unit (not shown) that transmits the file according to the request of the user terminal.

The device described above may be implemented as a hardware component, a software component, and/or a combination of the hardware component and the software component. For example, the devices and components described in the embodiments may be implemented by using at least one general-purpose or special-purpose computer such as a processor, a controller, an arithmetic logic unit (ALU), a digital signal processor, a microcomputer, a field programmable gate array (FPGA), a programmable logic unit (PLU), a microprocessor, or any other device capable of executing and responding to an instruction. The processing device may execute an operating system (OS) and at least one software application executed on the operating system. In addition, the processing device may access, store, manipulate, process, and create data in response to the execution of the software. For the further understanding, in some cases, one processing device may be used, however, those skilled in the art will be appreciated that e processing device may include a plurality of processing elements and/or a plurality of types of processing elements. For example, the processing device may include a plurality of processors or one processor and one controller. In addition, other processing configurations, such as a parallel processor, are also possible.

The software may include a computer program, a code, an instruction, or a combination of at least one thereof, and may configure the processing device to operate as desired or instruct the processing device independently or collectively. In order to be interpreted by the processor or to provide instructions or data to the processor, the software and/or data may be permanently or temporarily embodied in any type of machine, component, physical device, virtual equipment, and computer storage medium or device. The software may be distributed over computing devices connected to networks, so as to be stored or executed in a distributed manner. The software and data may be stored in at least one computer-readable recording medium.

The method according to the embodiment may be implemented in the form of a program instruction that may be executed through various computer mechanisms, and may be recorded in a computer-readable medium. The computer-readable medium may also include, alone or in combination with the program instructions, data files, data structures, and the like. The program instruction recorded in the medium may be specially designed and configured for the embodiment, or may be publicly known and available to those skilled in the art of computer software. Examples of computer-readable recording media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although the above description has been made with reference to specific embodiments and drawings, various modifications and changes can be made by those skilled in the art the above description. For example, even when the described techniques are performed in an order that is different from the described manner, and/or the described components such as systems, structures, devices, and circuits are coupled or combined in a form that is different from the described manner, or replaced or substituted by other components or equivalents, appropriate results may be achieved. Therefore, other implementations, other embodiments, and equivalents of the claims are within the scope of the following claims.

What is claimed is:

1. A method for inspecting a cosmetic packaging design based on object recognition and policy, which is implemented by a computing device including one or more processors and one or more memories for storing instructions executable in the processors, the method comprising:
a data extracting step of extracting, when design data of packaging paper including a packaging label or packaging box of a cosmetic container is collected from an external terminal, product information data indicating attribute information of cosmetics including at least text information, as information included in design data;
a description checking step of determining whether there exists essential description of the attribute information of the cosmetics, which is required to be described on the packaging paper, based on the product information data extracted from the data extracting step and a pre-stored attribute information regulation for cosmetics;
a description suitability determining step of determining description suitability of the product information data based on the product information data about the essential description and the attribute information regulation, when there is the essential description exists; and
a result providing step of providing a user account with result data that is generated as a result of the description checking step and the description suitability determining step.

2. The method of claim 1, wherein the data extracting step includes:
a first extracting step of collecting first text by separating text from an image when the design data is data in which the image and text are combined;
a second extracting step of collecting second text by extracting text information from the image using an artificial intelligence character recognition and keyword extraction algorithm for the image; and
a third extracting step of extracting product information data, which corresponds to a classification value of each attribute information of the cosmetics, from the first text and the second text by using a natural language schematic mining algorithm for the first text and the second text, to assign the product information data to the classification value of each attribute information.

3. The method of claim 1, wherein the description checking step includes checking whether the essential description is described based on existence of product information data in the attribute information about all essential descriptions by matching the attribute information, which is assigned to each extracted product information data, based on the classification value of the attribute information of the essential description.

4. The method of claim 3, wherein the description checking step includes additionally checking existence of a mark of functionality information and product information data about ultraviolet protection levels including SPF and PA in the essential description, when there exists product information data about at least one of the functionality information and information about whether the cosmetic is a sun care product in the attribute information.

5. The method of claim 1, wherein a classification value of the attribute information of the essential description includes a brand name, a cosmetic name, a capacity, a manufacturer, a responsible seller, a manufacturing number, and a total ingredient table, further includes a functionality mark when the cosmetic is functional cosmetics, and further includes an ultraviolet protection level when the cosmetic is a sun care product.

6. The method of claim 1, wherein the description suitability determining step includes:
a reference information extracting step of extracting reference information about the description suitability by applying the classification value of the attribute information of the essential description to which the product information data belongs to the pre-stored attribute information regulation of the cosmetics; and
a determining step of determining whether the extracted product information data satisfies each reference information by applying the extracted reference information to each extracted product information data.

7. The method of claim 6, wherein the reference information is one of a first reference in which an ingredient name written in a total ingredient table is to be marked when the ingredient name is written in a cosmetic name, and a second reference in which there is a keyword corresponding to ingredient information, which corresponds to a functionality mark, in the total ingredient table when there is the keyword indicating the functional cosmetics.

8. The method of claim 1, further comprising, after the description checking step:
an additional data identifying step of determining whether there exists additional data, which is product information data other than the essential description;
an additional data generating step of generating recommended additional data, which is information about usage, storage, and handling of the cosmetics, as information that is generated using a generation-type artificial intelligence algorithm for the product information data; and
a data recommending step of providing the user account with the additional data and the recommended additional data generated in the additional data generating step so that the user account recognizes information to be added to the design data.

9. An apparatus for inspecting a cosmetic packaging design based on object recognition and policy, which is implemented by a computing device including one or more processors and one or more memories for storing instructions executable in the processors, the apparatus comprising:
a data extracting unit that extracts, when design data of packaging paper including a packaging label or packaging box of a cosmetic container is collected from an external terminal, product information data indicating attribute information of cosmetics including at least text information, as information included in the design data;
a description checking unit that determines whether there exists essential description of the attribute information of the cosmetics, which is required to be described on the packaging paper, based on the product information data extracted from the data extracting step and a pre-stored attribute information regulation for cosmetics;
a description suitability determining unit that determines description suitability of the product information data based on the product information data about the essential description and the attribute information regulation, when the essential description exists; and
a result providing unit that provides a user account with result data that is generated as a result of performing functions of the description checking unit and the description suitability determining unit.

10. A computer-readable recording medium that stores instructions for enabling a computing device to perform the following steps, wherein the steps comprise:
a data extracting step of extracting, when design data of packaging paper including a packaging label or packaging box of a cosmetic container is collected from an external terminal, product information data indicating attribute information of cosmetics including at least text information, as information included in design data;
a description checking step of determining whether there exists essential description of the attribute information of the cosmetics, which is required to be described on the based on the product information data packaging paper, extracted from the data extracting step and a pre-stored attribute information regulation for cosmetics;
a description suitability determining step of determining description suitability of the product information data based on the product information data about the essential description and the attribute information regulation, when there is the essential description exists; and
a result providing step of providing a user account with result data that is generated as a result of the description checking step and the description suitability determining step.
